(19) United States
(12) Patent Application Publication
(10) Pub. No.: US 2012/0174125 A1
(43) Pub. Date: Jul. 5, 2012

(54) OPTICAL DISC DRIVE

(76) Inventors: Sang-hun KIM, Suwon-si (KR); Jung-hwan Na, Hwaseong-si (KR); Sang-hum Cho, Suwon-si (KR)

(21) Appl. No.: 13/242,742

(22) Filed: Sep. 23, 2011

(30) Foreign Application Priority Data
Dec. 31, 2010 (KR) 10-2010-0140690

(51) Int. Cl. G11B 17/04

(52) U.S. Cl. 720/601; G9B/17.013

(57) ABSTRACT

An optical disc drive is provided. The optical disc drive may include a housing, a tray that is received in the housing, an optical pickup device that is operatively coupled to the tray, connector that is installed in the housing and outputs a signal obtained from the optical pickup device, and a ribbon cable having an end portion connected to the connector, a fixed portion, and a movable portion folded so as not to be disposed parallel to the fixed portion.

### CROSS-REFERENCE TO RELATED PATENT APPLICATION

This application claims the benefit of Korean Patent Application No. 10-2010-0140690, filed on Dec. 31, 2010, in the Korean Intellectual Property Office, the entire disclosure of which is incorporated herein by reference for all purposes.

### BACKGROUND

1. Field

The following description relates to an optical disc drive.

2. Description of the Related Art

Generally, in a slim optical disc drive used in a laptop computer or the like, an optical pickup device is installed on a tray for receiving a disc and a main printed circuit board (PCB) for controlling the optical pickup device is installed in a housing (or a main body) for receiving the tray.

Because such an optical disc drive should meet a predetermined standard for maintaining compatibility with general laptop computers, design freedom is limited. In a conventional optical disc drive, an optical pickup device is mounted on a tray, a main PCB is installed on the tray, and the optical pickup device is mounted on guide shafts and a metal base on which the guide shafts are installed to allow a main body to reciprocate over the base.

Structurally, the optical pickup device has a complex structure, and the base is generally formed of a metal plate. Conventional optical drives have ribbon cables installed therein that are connected to an optical pick up device. However, such ribbon cables are folded in a way that in during motion of the optical disc drive tray, the signal lines in the ribbon cables overlap each other thereby causing signal interference or signal distortion.

### SUMMARY

According to one aspect an optical disc drive is provided. The optical disc drive includes a housing, a tray that is received in the housing, an optical pickup device that is operatively coupled to the tray, a connector that is installed in the housing and outputs a signal obtained from the optical pickup device, and a ribbon cable having an end portion connected to the connector, a fixed portion and a movable portion folded so as not to be disposed parallel to the fixed portion.

The optical pickup device may be mounted directly on the tray.

The ribbon cable may have at least one wire.

The optical disc drive may include guide shafts along which the optical pickup device reciprocates installed on the tray, and support posts for supporting the guide shafts that may integrally protrude from the tray.

The optical disc drive may include a plurality of support posts operatively coupled to the tray, and a plurality of guide shafts along which the optical pickup device reciprocates. The plurality of support posts may support the plurality of guide shafts.

A first portion of the plurality of guide shafts and a second portion of the plurality of guide shafts may each be operatively coupled to the tray along opposing sides of the tray.

The optical disc drive may include at least one through-hole that is formed on a side of housing.

The at least one through-hole may be formed so as to reduce capacitive coupling between the fixed portion of the ribbon cable and the housing.

A plurality of the through-holes may be formed along a specific wiring layer of the ribbon cable.

The optical disc drive may also include a feed motor having a screw, and a screw insertion portion that is operatively coupled to the optical pick up device such that as the feed motor drives rotation of the screw, the optical pick up device reciprocates along the plurality of guide shafts.

The optical disc drive may be included in a device.

The optical disc drive may be included in a computer.

The optical disc drive may be included in a video-displaying device.

The optical disc drive may be included in a terminal.

In another aspect, an optical disc drive is provided. The optical disc drive includes a housing having a base and a cover, a tray that is received in the housing, an optical pickup device that is mounted on the tray, a ribbon cable that has a plurality of wiring layers, a fixed portion corresponding to the base of the housing, and a movable portion folded so as not to be disposed parallel to the fixed portion, and a main printed circuit board that is installed on the tray and is connected to the ribbon cable.

Guide shafts along which the optical pickup device reciprocates may be installed on the tray, and support posts for supporting the guide shafts may integrally protrude from the tray.

The optical disc drive may include a plurality of support posts operatively coupled to the tray, and a plurality of guide shafts along which the optical pickup device reciprocates. The plurality of support posts may support the plurality of guide shafts.

A first portion of the plurality of guide shafts and a second portion of the plurality of guide shafts may each be operatively coupled to the tray along opposing sides of the tray.

The optical disc drive may include at least one through-hole that is formed in the base of the housing.

The at least one through-hole is formed so as to reduce capacitive coupling between the fixed portion of the ribbon cable and the housing.

A spindle motor may be mounted on the tray and a rotating shaft of the spindle motor may be directly fixed to the tray.

A spindle motor may be mounted on the tray and a rotating shaft of the spindle motor may be directly fixed to the tray.

In another aspect, an optical disc drive is provided. The optical disc drive includes a housing that has a base and a cover, a tray that is received in the housing, an optical pickup device that is mounted on the tray, a main printed circuit board that is installed on the tray and is connected to a ribbon cable, and a connector that is installed on the base. The ribbon cable has a plurality of wiring layers connected to the connector and the main printed circuit board, a fixed portion corresponding to the base, and a movable portion folded so as not to be disposed parallel to the fixed portion.

Guide shafts along which the optical pickup device reciprocates may be installed on the tray, and support posts for supporting the guide shafts may integrally protrude from the tray.

The optical disc drive may also include a plurality of support posts operatively coupled to the tray, and a plurality of guide shafts along which the optical pickup device reciprocates. The plurality of support posts may support the plurality of guide shafts.

A first portion of the plurality of guide shafts and a second portion of the plurality of guide shafts may each be operatively coupled to the tray along opposing sides of the tray.

The optical disc drive may include at least one through-hole that is formed in the base of the housing.

The at least one through-hole may be formed so as to reduce capacitive coupling between the fixed portion of the ribbon cable and the housing.

A spindle motor may be mounted on the tray, and a rotating shaft of the spindle motor may be directly fixed to the tray.

A plurality of the through-holes may be formed along a specific wiring layer of the plurality of wiring layers of the ribbon cable.

Other features and aspects may be apparent from the following detailed description, the drawings, and the claims.

### BRIEF DESCRIPTION OF THE DRAWINGS

FIG. 1 is a diagram illustrating an example of an optical disc drive.

FIG. 2 is a diagram illustrating an example of a tray of an optical disk drive.

FIG. 3 is a diagram illustrating an example of a spindle motor directly mounted on the tray of an optical disc drive.

FIG. 4 is a diagram illustrating an example of guide shafts and support posts that support the guide shafts of the tray of an optical disc drive.

FIGS. 5A and 5B are diagrams that illustrate examples of the support posts that support the guide shafts of the tray of an optical disc drive.

FIG. 6 is a diagram illustrating an example of a main printed circuit board (PCB) mounted on a bottom surface of the tray of an optical disc drive.

FIG. 7 is a diagram illustrating an example of the main PCB of an optical disc drive.

FIG. 8 is a diagram illustrating an example of a ribbon cable for signal transmission disposed on a base of a housing of an optical disc drive.

FIG. 9 is a diagram illustrating an example of a state where a ribbon cable is folded.

FIG. 10 is a diagram illustrating an example of through-holes formed in a bottom of the housing and adapted to suppress capacitive coupling between the bottom of the housing and the ribbon cable of an optical disc drive.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

According to an aspect, an optical disc drive is provided in which signal interference in a ribbon cable for signal transmission is suppressed. Further, an optical disc drive is provided such that the number of processes and the number of parts are reduced, thereby reducing the manufacturing costs.

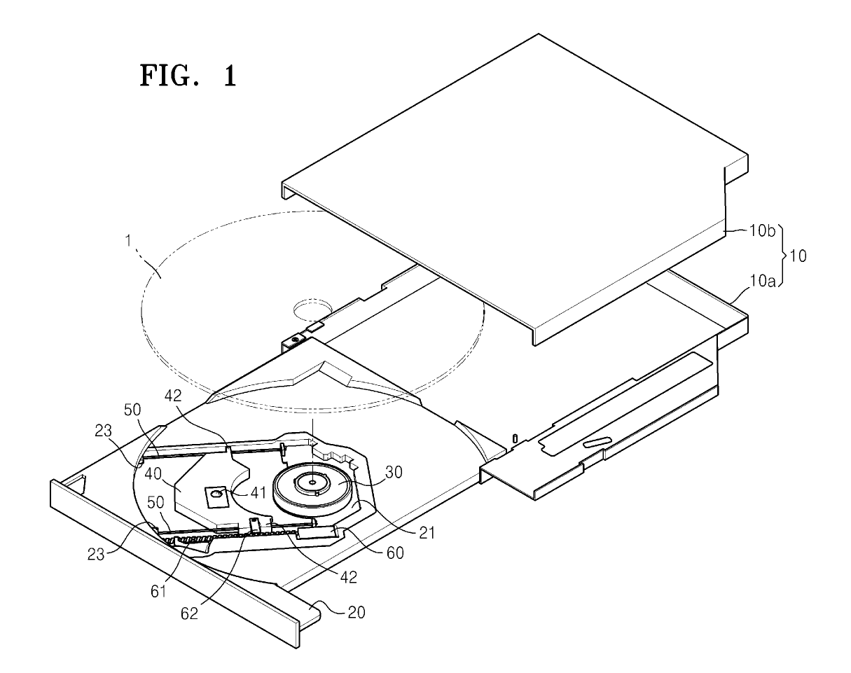

FIG. 1 is a diagram illustrating an example of an optical disc drive.

Referring to FIG. 1, the optical disc drive has a housing 10 in which a tray 20 is installed. Housing 10 may include a base 10a and a cover 10b .Tray 20 slides in and out of a housing 10. An optical pick up device 40 is mounted on the tray 20. A spindle motor 30 may also be mounted on the tray 20.

As an example, two guide shafts 50 which are disposed parallel to each other may be fixed to the tray 20. The optical pickup device 40 may be installed on the guide shafts 50. The optical pickup device 40 may include an objective lens 41 and an actuator (not shown) for driving the objective lens 41, and guide portions 42 for sliding along the shafts 50 may be disposed on opposite sides of the optical pickup device 40. In addition, as an example, a feed motor 60 including a screw 61 may be included. The feed motor 60 and the screw 61 is a device for reciprocating the optical pickup device 40. The screw 61 engages with a screw insertion portion 62 that may be coupled to the optical pickup device 40. Accordingly, as the screw 61 rotates, the optical pickup device 40 reciprocates along the guide shafts 50.

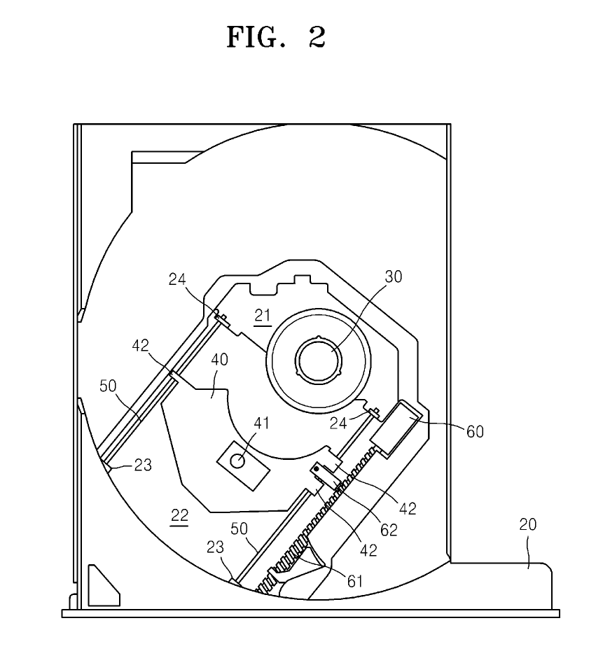

FIG. 2 is a diagram illustrating an example of the tray 20 of the optical disc drive of FIG. 1.

The tray 20 may have a space portion 22 in which the optical pickup device 40 is installed and is movable.

For example, the shafts 50 may be disposed parallel to each other on opposite sides of the space portion 22. Ends of each of the shafts 50 are supported by support posts 23 and 24 that may be disposed on the tray 20. As an example, the support posts 23 and 24 may be integrally formed with the tray 20, or the support posts 23 and 24 may be operatively coupled to the tray 20. Ends of the optical pickup device 40 may be supported on the guide shafts 50 by the guide portions 42, and the screw insertion portion 62 engaged with the screw 61 of the feed motor 60 may be disposed on a side of the optical pickup device 40.

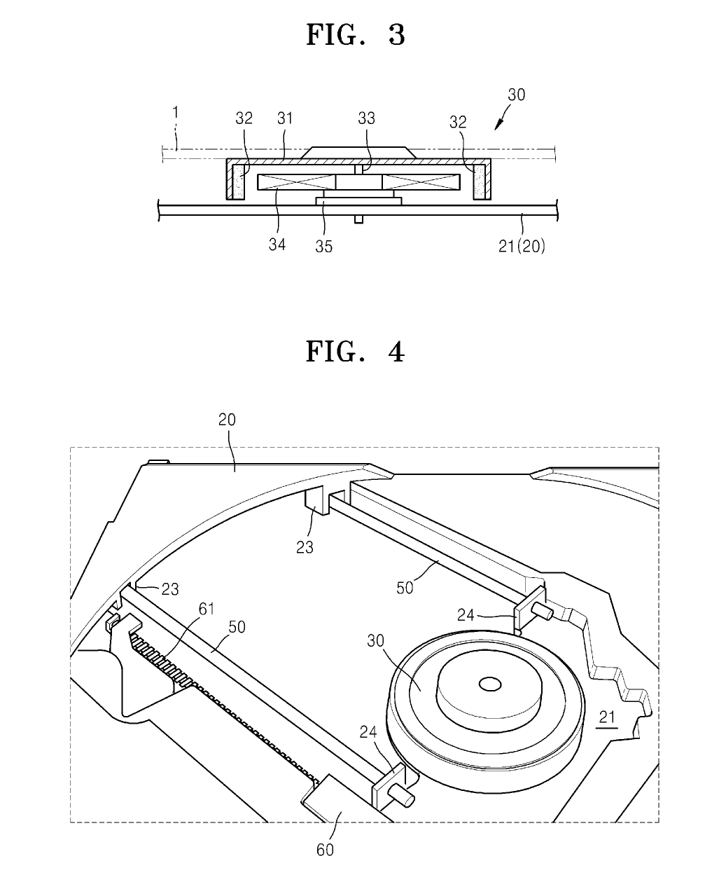

As an example, a motor base 21 that functions as a base of the spindle motor 30 may be disposed on a side of the space portion 22 of the tray 20. For example, FIG. 3 is a diagram illustrating a spindle motor 30 directly mounted on the tray 20 of an optical disc drive. As shown in FIG. 3, the motor base 21 is a part of the tray 20 to which a shaft support portion 35 having a bearing (not shown) for supporting a rotating shaft 33 of the spindle motor 30 is fixed. A magnetic coil portion 34 that is a stator may be fixed to an upper end of the shaft support portion 35, and a permanent magnet 32 may be disposed inside a rotor 31 having a top surface on which a disc 1 is mounted. For example, without a separate motor base including a spindle motor, a part of the tray 20 may be used as a motor base. Accordingly, because the spindle motor 30 in this example is mounted on a part of the tray 20, a complete motor is realized

FIG. 4 is a diagram illustrating an example of the guide shafts 50 and the support posts 23 and 24 of the tray 20 of an optical disc drive. Referring to FIG. 4, the support posts 23 and 24 for supporting the guide shafts 50 are fixed.

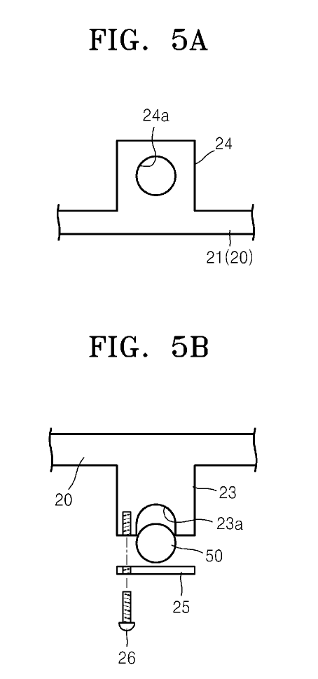

The support posts 23 and 24 that support the ends of each of the shafts 50 may be disposed on a bottom surface of one side of the tray 20 and on one side of the motor base 21. As an example, the support posts 24 may each have a through-hole 24a as illustrated in FIG. 5A. One end of each of the shafts 50 may be respectively inserted into each of the through-holes 24a. As an example, the support posts 23 may each have an insertion groove 23a as illustrated in FIG. 5B. Each of the shafts 50 may be respectively inserted into each of the insertion grooves 23a from below the insertion grooves 23a and support members 25 for preventing separation of the shafts 50 from the insertion grooves 23a and screws 26 for fixing the support members 25 may be operatively coupled to portions of the support posts 23 including the insertion grooves 23a.

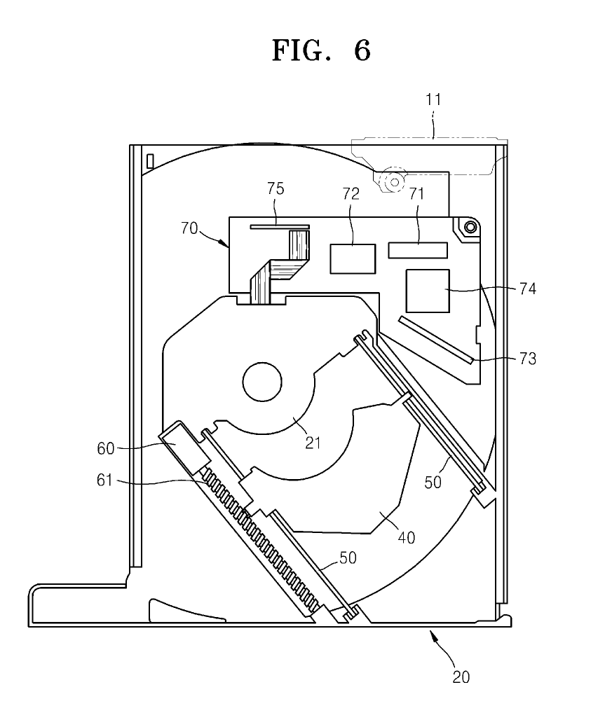

FIG. 6 is a diagram illustrating an example of a main printed circuit board (PCB) 70 mounted on a bottom surface of the tray 20 of an optical disc drive. In FIG. 6, the optical pickup device 40 and the guide shafts 50 are not shown.

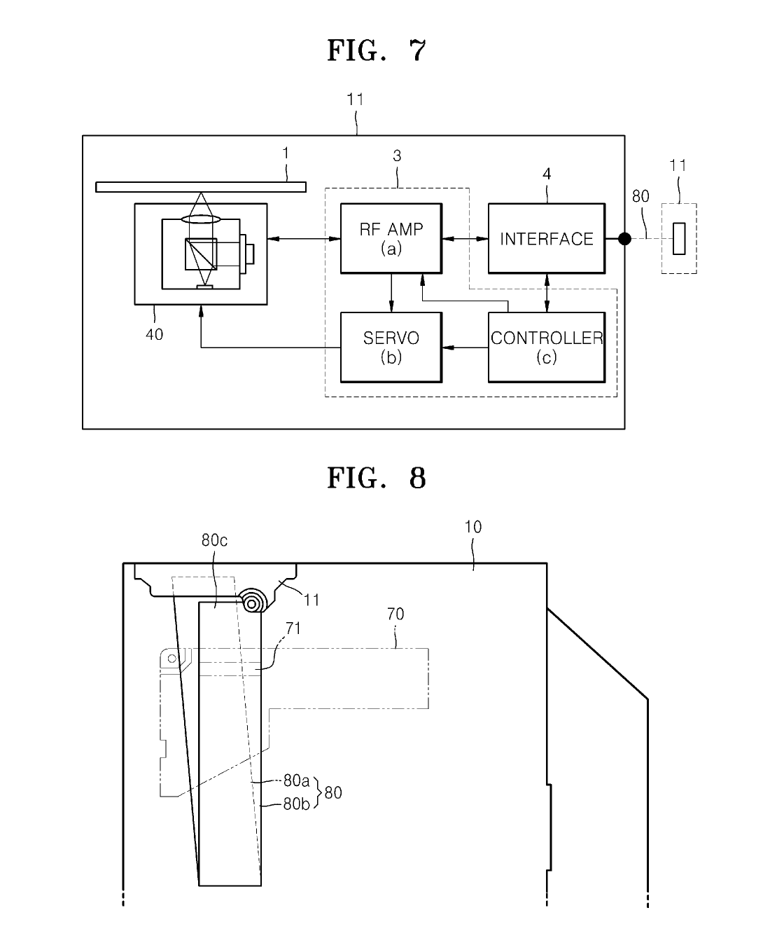

As an example, the main PCB 70 of the optical disc drive may be disposed on the bottom surface of the tray 20. The main PCB, which is a so-called front-end part, may include a high frequency amplifier (e.g., a radio frequency (RF) amplifier), a servo circuit, an interface, and so on. For example, FIG. 7 is a diagram illustrating the main PCB 70 of an optical disc drive. In FIG. 6, reference numeral 71 denotes an interface connector for output, reference numeral 73 denotes a connector connected to the optical pickup device 40, reference numerals 72 and 74 denote chipsets such as, for example, a Micom, and reference numeral 75 denotes a connector connected to the spindle motor 30 or the like.

A front-end system 3 may include, for example, an RF amplifier (a) for amplifying a signal from the optical pickup device 40, a servo unit (b) for controlling a tracking and focusing mechanism of the optical pickup device 40, and a system control unit (c) for controlling the RF amplifier (a) and the servo unit (b). In the front-end system 3, a current/voltage amplifier may be disposed at a front end of the RF amplifier (a). The RF amplifier outputs raw-data (signal) obtained by finally amplifying a high frequency signal to a master device, for example, a laptop computer, via an interface 4.

As such, when the main PCB 70 is mounted on the bottom surface of the tray 20, an existing interface device does not need to be installed in the housing 10, and simply a connector for interface, for example, a serial advanced technology attachment (SATA) connector, may be disposed.

FIG. 8 is a diagram illustrating an example of a ribbon cable 80 for signal transmission disposed on the base 10a of the housing 10a of an optical disc drive. Referring to FIG. 8, an interface connector 11 for output may be disposed on a real end of the housing 10. For example, the interface connector 11 for output may be disposed on one side of the base 10a and the ribbon cable 80, which may be a flexible film cable (FFC), and is connected to the interface connector 71 may be disposed on the tray 20.

In order to correspond to a drawer-like motion of the tray 20, the ribbon cable 80 may include a fixed portion 80a facing the base 10a and a movable portion 80b that is movable while being folded on the fixed portion 80a. A front end portion of the movable portion 80b is coupled to the interface connector 71 disposed on the tray 20. The fixed portion 80a and the movable portion 80b are disposed so as to not be parallel to each other, and are misaligned with each other in a “V” shape, in order to prevent signal lines of the fixed portion 80a and the movable portion 80b of the ribbon cable 80 from overlapping each other, and thus in order to prevent signal interference that occurs when signal lines through which data is transmitted overlap each other. As such, signal interference is prevented by misaligning the fixed portion 80a with the movable portion 80b. In addition, abnormal distortion of the movable portion 80b during movement of the tray 20 is prevented by disposing the movable portion 80b in parallel to a direction in which the tray 20 moves.

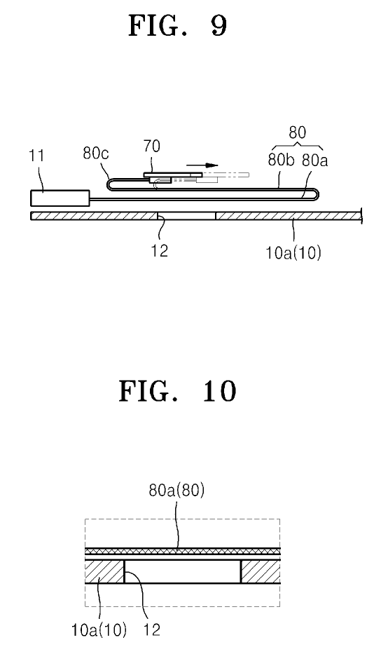

FIG. 9 is a diagram illustrating an example of a state where the ribbon cable 80 is folded.

As an example, the ribbon cable 80 may be folded at two points. The fixed portion 80a as a lowermost portion is fixed to the base 10a of the housing 10, and the movable portion 80b over the fixed portion 80a may have a bent shape due to a bent portion 80c. The ribbon cable may have a non-linear shape due to the fixed portion 80a, the movable portion 80b, and the bent portion 80c. In response to the main PCB 70 moving as the tray 20 moves, a position of the bent portion 80c on the movable portion 80b may be changed.

As an example, as shown in FIGS. 8, 9, and 10, a plurality of through-holes 12 that pass through the base 10a of the housing 10 may be formed under the fixed portion 80a of the ribbon cable 80. The through-holes 12 suppress signal distortion and signal interference by suppressing capacitive coupling between the ribbon cable 80 and one side of a body of the housing 10, for example, the base 10a. The ribbon cable 80 may include a plurality of wiring layers, and a wiring layer that acts as a signal line through which an RF signal is output exists in the plurality of wiring layers. The plurality of through-holes 12 may be formed along a specific wiring layer, and may be formed to correspond to, for example, a wiring layer through which a data signal flows. For example, if the ribbon cable 80 meets a SATA standard, A+, A−, B+, and B− differential signal lines exist, and the through-holes 12 may be formed at positions corresponding to the A+, A−, B+, and B− differential signal lines, particularly, the B+and B− lines through which a signal is transmitted to a host. Accordingly, the through-holes 12 may reduce capacitive coupling between a data line and the body of the housing 10, thereby reducing signal interference, signal distortion, and the like.

In some examples, because an optical pickup device is directly mounted on a tray, the number of parts may be reduced, the number of processes may be reduced, and thus costs may be reduced. For example, because the optical pickup device may be mounted on the tray without a separate base, an inner space may be increased by a thickness of the base.

Furthermore, according to some examples, because a spindle motor manufactured as an independent part may be mounted on the tray, the number of parts may be reduced.

In addition, according to some examples, because a main PCB may be mounted on the tray, a distance between the optical pickup device and the main PCB may be reduced.

According to some examples, because through-holes for suppressing capacitive coupling may be formed, signal loss, signal interference, signal distortion, and so on may be suppressed.

The optical disc drive described in the examples herein may be included in an electronic apparatus. For example, the optical disc drive may be or may be included in a terminal such as a portable terminal, a computer, a tablet, a camera, a home appliance, and the like. As a non-exhaustive illustration only, a terminal described herein may refer to a computer or computing system, a portable game console, and a portable/personal multimedia player (PMP), a portable lab-top PC, and devices such as a desktop PC, a high definition television (HDTV), an optical disc player, a setup box, and the like capable of wireless communication or network communication consistent with that disclosed herein.

The units described herein may be implemented using hardware components and software components. For example, microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums. The computer readable recording medium may include any data storage device that can store data which can be thereafter read by a computer system or processing device. Examples of the computer readable recording medium include read-only memory (ROM), random-access memory (RAM), CD-ROMs, magnetic tapes, floppy disks, optical data storage devices. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical disc drive comprising:
a housing:
a tray that is received in the housing;
an optical pickup device that is operatively coupled to the tray;
a connector that is installed in the housing and outputs a signal obtained from the optical pickup device; and
a ribbon cable having an end portion connected to the connector, a fixed portion, and a movable portion folded so as not to be disposed parallel to the fixed portion.

2. The optical disc drive of claim 1, wherein the optical pickup device is mounted directly on the tray.

3. The optical disc drive of claim 2, wherein the ribbon cable has at least one wire.

4. The optical disc drive of claim 3, wherein guide shafts along which the optical pickup device reciprocates are installed on the tray, and support posts for supporting the guide shafts integrally protrude from the tray.

5. The optical disc drive of claim 3, further comprising:
a plurality of support posts operatively coupled to the tray; and
a plurality of guide shafts along which the optical pickup device reciprocates;
wherein the plurality of support posts support the plurality of guide shafts.

6. The optical disc drive of claim 5, wherein
a first portion of the plurality of guide shafts and a second portion of the plurality of guide shafts each being operatively coupled to the tray along opposing sides of the tray.

7. The optical disc drive of claim 3, further comprising at least one through-hole that is formed on a side of housing.

8. The optical disc drive of claim 7, wherein the at least one through-hole is formed so as to reduce capacitive coupling between the fixed portion of the ribbon cable and the housing.

9. The optical disc drive of claim 7, wherein a plurality of the through-holes are formed along a specific wiring layer of the ribbon cable.

10. An optical disc drive comprising:
a housing that comprises a base and a cover;
a tray that is received in the housing;
an optical pickup device that is mounted on the tray;
a ribbon cable that comprises a plurality of wiring layers, a fixed portion corresponding to the base of the housing, and a movable portion folded so as not to be disposed parallel to the fixed portion; and
a main printed circuit board that is installed on the tray and is connected to the ribbon cable.

11. The optical disc drive of claim 5, wherein guide shafts along which the optical pickup device reciprocates are installed on the tray, and support posts for supporting the guide shafts integrally protrude from the tray.

12. The optical disc drive of claim 10, further comprising:
a plurality of support posts operatively coupled to the tray; and
a plurality of guide shafts along which the optical pickup device reciprocates;
wherein the plurality of support posts support the plurality of guide shafts.

13. The optical disc drive of claim 12, wherein
a first portion of the plurality of guide shafts and a second portion of the plurality of guide shafts are each being operatively coupled to the tray along opposing sides of the tray.

14. The optical disc drive of claim 10, further comprising at least one through-hole that is formed in the base of the housing.

15. The optical disc drive of claim 14, wherein the at least one through-hole is formed so as to reduce capacitive coupling between the fixed portion of the ribbon cable and the housing.

16. The optical disc drive of claim 10, wherein a spindle motor is mounted on the tray and a rotating shaft of the spindle motor is directly fixed to the tray.

17. The optical disc drive of claim 11, wherein a spindle motor is mounted on the tray and a rotating shaft of the spindle motor is directly fixed to the tray.

18. An optical disc drive comprising:
a housing that comprises a base and a cover;
a tray that is received in the housing;
an optical pickup device that is mounted on the tray;
a main printed circuit board that is installed on the tray and is connected to a ribbon cable; and
a connector that is installed on the base;
wherein the ribbon cable has a plurality of wiring layers connected to the connector and the main printed circuit board, a fixed portion corresponding to the base, and a movable portion folded so as not to be disposed parallel to the fixed portion.

19. The optical disc drive of claim 18, wherein guide shafts along which the optical pickup device reciprocates are installed on the tray, and support posts for supporting the guide shafts integrally protrude from the tray.

20. The optical disc device of claim 18, further comprising:
a plurality of support posts operatively coupled to the tray; and
a plurality of guide shafts along which the optical pickup device reciprocates;
wherein the plurality of support posts support the plurality of guide shafts.

21. The optical disc device of claim 20, wherein
a first portion of the plurality of guide shafts and a second portion of the plurality of guide shafts are each being operatively coupled to the tray along opposing sides of the tray.

22. The optical disc drive of claim 18, further comprising at least one through-hole that is formed in the base of the housing.

23. The optical disc drive of claim 22, wherein the at least one through-hole is formed so as to reduce capacitive coupling between the fixed portion of the ribbon cable and the housing.

24. The optical disc drive of claim 19, wherein a spindle motor is mounted on the tray, and a rotating shaft of the spindle motor is directly fixed to the tray.

25. The optical disc drive of claim 18, wherein a spindle motor is mounted on the tray, and a rotating shaft of the spindle motor is directly fixed to the tray.

26. The optical disc drive of claim 22, wherein a plurality of the through-holes are formed along a specific wiring layer of the plurality of wiring layers of the ribbon cable.

27. The optical disc drive of claim 13, further comprising:
a feed motor including a screw; and
a screw insertion portion that is operatively coupled to the optical pick up device such that as the feed motor drives rotation of the screw, the optical pick up device reciprocates along the plurality of guide shafts.

28. A device including the optical disc drive of claim 1.

29. The device of claim 28, wherein the optical disc drive is included in a computer.

30. The device of claim 28, wherein the optical disc drive is included in a video displaying device.

31. The device of claim 28, wherein the optical disc drive is included in a terminal.
